(19) United States
(12) Patent Application Publication
(10) Pub. No.: US 2025/0264959 A1
(43) Pub. Date: Aug. 21, 2025

(54) ELECTRONIC DEVICE AND METHOD FOR DRIVING TOUCH DISPLAY PANEL

(71) Applicant: Novatek Microelectronics Corp., Hsinchu (TW)

(72) Inventors: Chih Peng, Hsinchu City (TW); Hsin-Ting Chan, Taichung City (TW); Ding-Teng Shih, Hsinchu City (TW); Fan-Wei Kuo, Hsinchu County (TW)

(73) Assignee: Novatek Microelectronics Corp., Hsinchu (TW)

(21) Appl. No.: 18/581,323

(22) Filed: Feb. 19, 2024

(51) Int. Cl. G06F 3/041; G06F 3/044

(52) U.S. Cl. CPC G06F 3/0418; G06F 3/04166; G06F 3/044; G06F 2203/04104

(57) ABSTRACT

An electronic device configured to detect a touch event of a stylus and a hand is provided. The electronic device includes a touch display panel and a driver circuit. The touch display panel is configured to detect the touch event of the stylus and the hand. The touch display panel includes a plurality of driving lines. The driver circuit is coupled to the touch display panel. The driver circuit is configured to determine a first area and a second area. The stylus touches the first area, and the hand touches the second area. The driver circuit is configured to make the driving lines corresponding to the second area to be in a high impedance state when the touch display panel detects the touch event of the stylus and the hand.

### BACKGROUND

### Technical Field

The invention relates to an electronic device and a method for driving a touch display panel.

### Description of Related Art

In recent years, the use of smartphones and tablets with styluses has become more and more common. Styluses offer more precise clicks, smoother swipes, and more sophisticated drawings, expanding business opportunities. Users often rest their hands on the mobile device when using a stylus, rather than holding it, for comfort and stability. However, if the mobile device is placed on a desk, it will lead to a lower signal-to-noise ratio (SNR) of styluses having relatively small capacitive values, and thus styluses may fail to click or slide. This can make it challenging to distinguish styluses' touch from hands or other interference, resulting in poor user experience.

### SUMMARY

The invention is directed to an electronic device and a method for driving a touch display panel, capable of effectively distinguishing styluses' touch from hands or other interference, so as to provide good user experience.

An embodiment of the invention provides an electronic device configured to detect a touch event of a stylus and a hand. The electronic device includes a touch display panel and a driver circuit. The touch display panel is configured to detect the touch event of the stylus and the hand. The touch display panel includes a plurality of driving lines. The driver circuit is coupled to the touch display panel. The driver circuit is configured to determine a first area and a second area. The stylus touches the first area, and the hand touches the second area. The driver circuit is configured to make the driving lines corresponding to the second area to be in a high impedance state when the touch display panel detects the touch event of the stylus and the hand.

An embodiment of the invention provides a method for driving a touch display panel having a plurality of driving lines. The method includes detecting a touch event of a stylus and a hand; determining a first area and a second area, wherein the stylus touches the first area, and the hand touches the second area; and driving the driving lines corresponding to the second area to be in a high impedance state when the touch display panel detects the touch event of the stylus and the hand.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating an electronic device according to an embodiment of the invention.

FIG. 2 is a block diagram illustrating the electronic device of FIG. 1 according to an embodiment of the invention.

FIG. 3 is a schematic diagram illustrating an application scenario of the electronic device of FIG. 1 according to an embodiment of the invention.

FIG. 4A and FIG. 4B are schematic diagrams illustrating sensing units of the touch display panel and signal values thereof according to different embodiments of the invention.

FIG. 5 is a structure diagram illustrating a touch display panel according to an embodiment of the invention.

FIG. 6 is a schematic diagram illustrating the touch display panel of FIG. 5 including sensing units.

FIG. 7 is a flowchart illustrating steps in a method for driving a touch display panel according to an embodiment of the invention.

FIG. 8 is a flowchart illustrating steps in a method for driving a touch display panel according to another embodiment of the invention.

FIG. 9 is a waveform diagram illustrating a touch sensing signal, a common signal and a sensing data according to an embodiment of the invention.

### DESCRIPTION OF THE EMBODIMENTS

Embodiments are provided below to describe the disclosure in detail, though the disclosure is not limited to the provided embodiments, and the provided embodiments can be suitably combined. The term “coupling/coupled” or “connecting/connected” used in this specification (including claims) of the application may refer to any direct or indirect connection means. For example, “a first device is coupled to a second device” should be interpreted as “the first device is directly connected to the second device” or “the first device is indirectly connected to the second device through other devices or connection means.” In addition, the term “signal” can refer to a current, a voltage, a charge, a temperature, data, electromagnetic wave or any one or multiple signals.

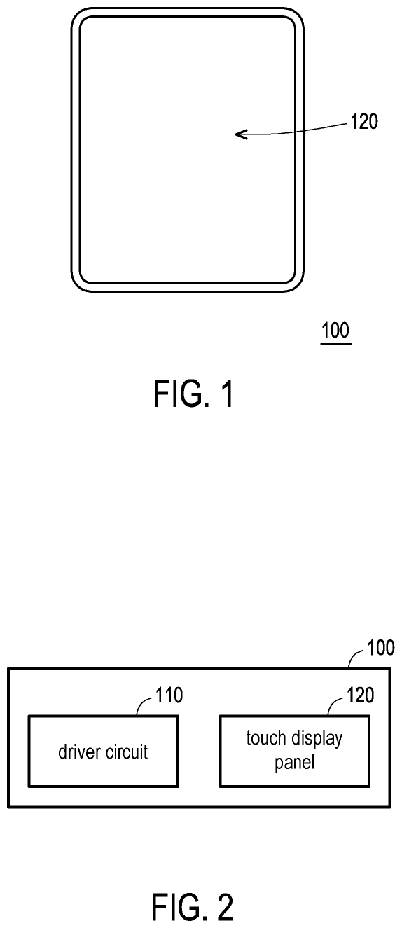

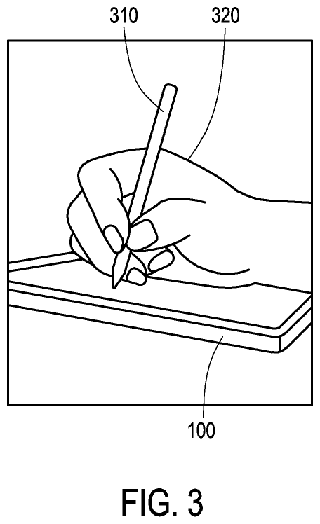

FIG. 1 is a schematic diagram illustrating an electronic device according to an embodiment of the invention. FIG. 2 is a block diagram illustrating the electronic device of FIG. 1 according to an embodiment of the invention. Referring to FIG. 1 and FIG. 2, the electronic device 100 includes a driver circuit 110 and a touch display panel 120. The driver circuit 110 is configurable to be coupled to the touch display panel 120. The electronic circuit 110 is adapted to drive the touch display panel 120.

In the present embodiment, the electronic device 100 may be an electronic device having a display function, a touch sensing function and/or a fingerprint sensing function. In an embodiment, the electronic device 100 may be, but not limited to, a smartphone, a non-smart phone, a wearable electronic device, a tablet computer, a personal digital assistant, a notebook and other portable electronic devices that can operate independently and have the display function, the touch sensing function and/or the fingerprint sensing function. In an embodiment, the electronic device 100 may be, but not limited to, a portable or un-portable electronic device in a vehicle intelligent system. In an embodiment, the electronic device 100 may be, but not limited to, intelligent home appliances such as, a television, a computer, a refrigerator, a washing machine, a telephone, an induction cooker, a table lamp and so on.

In an embodiment, when the electronic circuit 110 is implemented as a single chip integrated circuit that can drive and control the touch display panel 120 to perform the display operation, the touch sensing operation and/or the fingerprint sensing operation, the electronic circuit 110 may include a control circuit, and the control circuit may be a micro-controller based core to perform all of control activities of the display operation, the touch sensing operation and/or the fingerprint sensing operation.

Regarding hardware structures of the components in the embodiment of FIG. 2, the driver circuit 110 may includes a processor having computational capability. Alternatively, the driver circuit 110 may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC). In addition, enough teaching, suggestion, and implementation illustration for hardware structures of the driver circuit 110 and the touch display panel 120 can be obtained with reference to common knowledge in the related art.

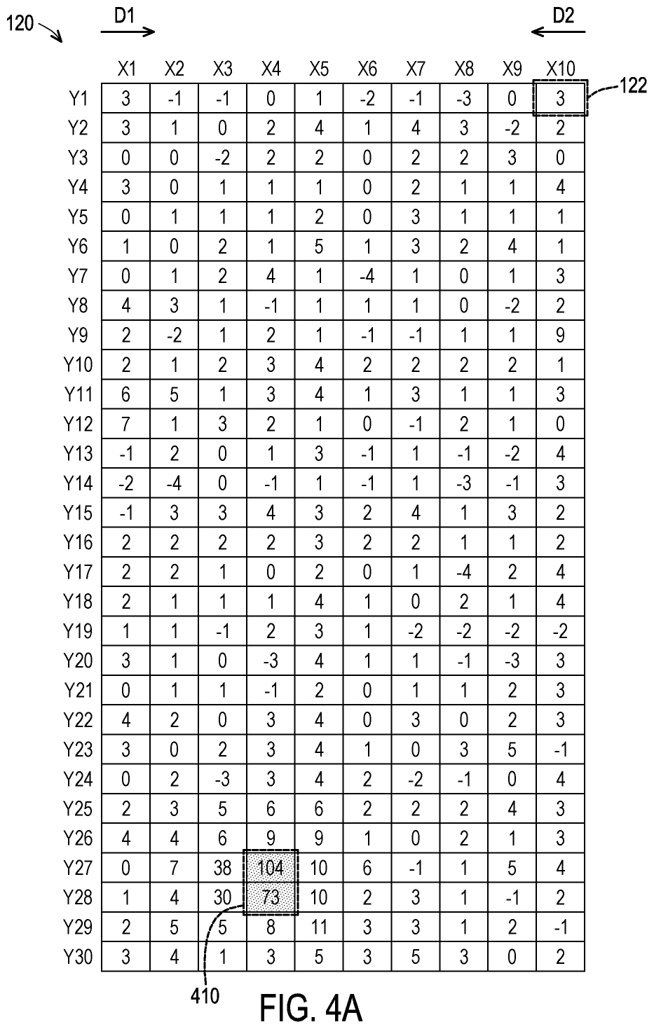

FIG. 3 is a schematic diagram illustrating an application scenario of the electronic device of FIG. 1 according to an embodiment of the invention. Referring to FIG. 1 to FIG. 3, taking a portable electronic device for example, the electronic device 100 is configured to detect a touch event of a stylus 310 and a hand 320 of a user. The driver circuit 110 is configured to drive the touch display panel 120 to detect the touch event of the stylus 310 and the hand 320. The touch display panel 120 may include an active area and a peripheral area, and the active area is configured to be a detection area for detecting the touch event. The application scenario of FIG. 3 is taking for example, and does not intend to limit the invention.

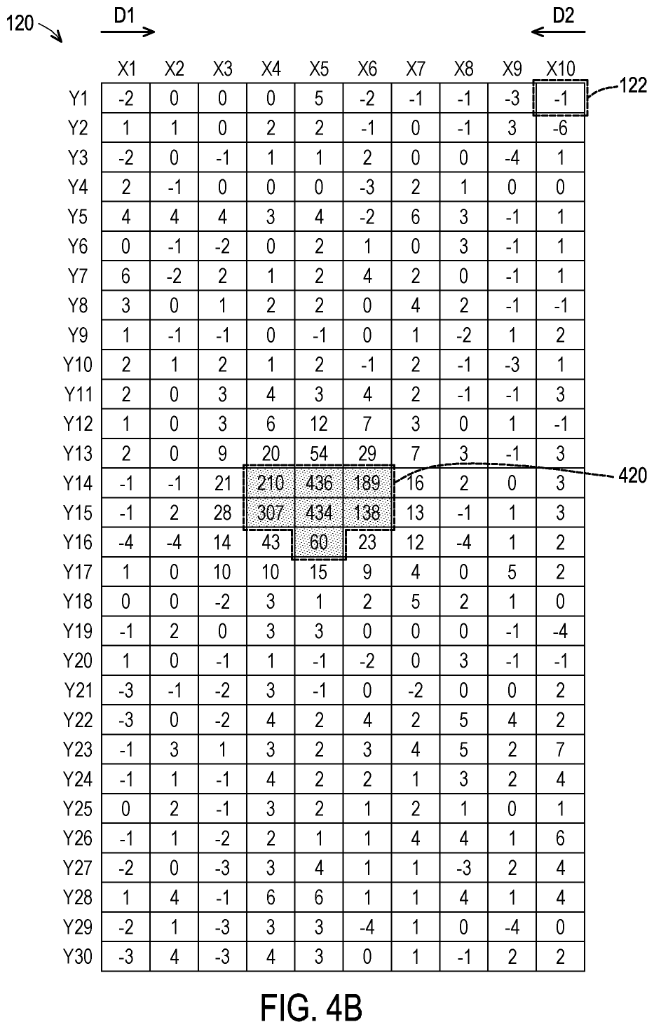

In the present embodiment, objects such as passive capacitive styluses or gloves may have relatively small signal values compared to hands. To be specific, FIG. 4A and FIG. 4B are schematic diagrams illustrating sensing units of the touch display panel and signal values thereof according to different embodiments of the invention. Referring to FIG. 3 to FIG. 4B, the touch display panel 120 includes a plurality of touch sensing units 122. The touch sensing units 122 are arranged in an array, which includes a plurality of columns X1 to X10 and a plurality of rows Y1 to Y30. The signal values in figures are capacitive values of the touch sensing units 122.

In the present embodiment, the driver circuit 110 may drive the touch display panel 120 to perform a scan operation to detect touch events. For example, the touch display panel 120 may perform the scan operation in a horizontal direction, and the columns X1 to X10 of the touch sensing units 122 are scanned from two sides to a center, as illustrated in scan directions D1 and D2. The scan directions D1 and D2 are taking for example, and do not intend to limit the invention. In addition, the signal values and the number of the touch sensing units 122, the number of the columns X1 to X10, and the number of the rows Y1 to Y30 are taking for example, and do not intend to limit the invention.

FIG. 4A illustrates a case that only the stylus 310 touches the touch display panel 120. In FIG. 4A, the stylus 310 touches a detection area 410, and the detection area 410 has relatively large signal values compared to other detection area. FIG. 4B illustrates a case that only the hand 320 touches the touch display panel 120. In FIG. 4B, the hand 320 touches a detection area 420, and the detection area 420 has relatively large signal values compared to other detection area.

From FIG. 4A and FIG. 4B, the detection area 410 of the stylus 310 has relatively small signal values compared to the detection area 420 of the hand 320. Therefore, the signal values of the hand 320 may affect the signal values of the stylus 310 when the touch display panel 120 detects the touch event of the stylus 310 and the hand 320.

To reduce the impact of hands or other interference, in the embodiments of the invention, the driver circuit 110 is configured to make driving lines of other detection area other than the detection area 410 to be in a high impedance state when the touch display panel 120 detects the touch event of the stylus 310 and the hand 320.

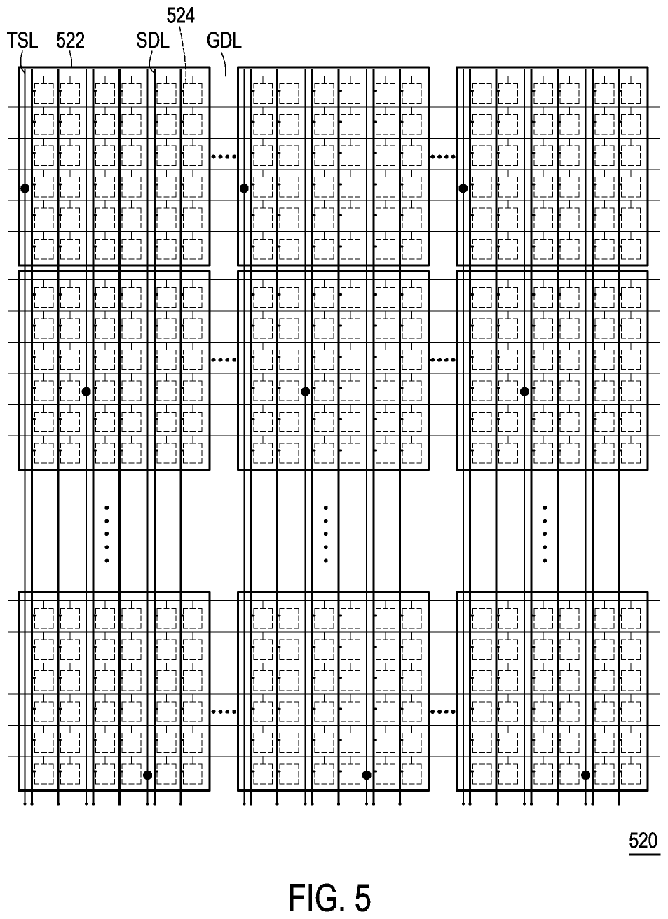

FIG. 5 is a structure diagram illustrating a touch display panel according to an embodiment of the invention. Referring to FIG. 5, the touch display panel 520 includes a plurality of touch sensors 522 and a plurality of display pixels 524. One sensing unit includes multiple touch sensors 522. In an embodiment, each touch sensor may be formed by connecting a plurality of common electrodes which are provided with a display common voltage in a display phase. In another aspect, the touch sensors 522 may serve as common electrodes in the display phase.

To be specific, the driver circuit 110 drives the display pixels 524 to display images via display scan lines GDL and display data lines SDL. Each display pixel 524 represents a pixel which is not a subpixel but a basic unit of a display resolution, such as a full-color pixel including R, G, B subpixels. Each display data line SDL represents a data line group including a plurality of data lines with respect to a display pixel.

The driver circuit 110 also drives and controls the touch sensors 522 to sense touch events via driving lines TSL. For self-capacitance touch sensing, touch driving signals and touch sensing signals may be both transmitted on the driving lines TSL. For mutual-capacitance touch sensing, the touch display panel 520 may further include sensing lines for transmitting the touch sensing signals. In an embodiment, the touch display panel 520 may be an in-cell touch and display panel that the touch sensors are embedded, but the invention is not limited thereto.

In the present embodiment, the driving lines TSL may be connected to corresponding switches (not shown). The driver circuit 110 can turn off the corresponding switches to make the driving lines of the second area to be in the high impedance state.

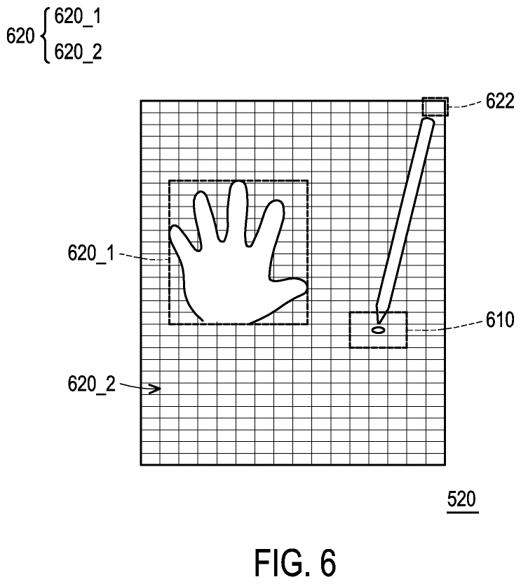

For example, FIG. 6 is a schematic diagram illustrating the touch display panel of FIG. 5 including sensing units. Referring to FIG. 5 to FIG. 6, the touch display panel 520 includes a plurality of sensing units 622, and one sensing unit 622 includes multiple touch sensors 522. At least one of the touch sensing units 622 forms a detection area. The touch display panel 520 includes a plurality of driving lines. The stylus 310 touches the first area 610, and the hand 320 touches the second area 620. The second area 620 is all detection area on the touch display panel 520 other than the first area 610. The second area 620 is larger than the first area 610. The driver circuit 110 can determine the first area 610 and the second area 620, and turn off the switches connected to the driving lines corresponding to the second area, so that the driving lines corresponding to the second area are in the high impedance state when the touch display panel 520 detects the touch event of the stylus 310 and the hand 320. The driving lines corresponding to the second area may be selected from corresponding part of the driving lines TSL of FIG. 5. Therefore, the driver circuit 110 can make the driving lines corresponding to the second area to be in a high impedance state, and only scan the first area 610 of the touch display panel 520 during a touch term.

In addition, the second area 620 includes a first subarea 620_1 and a second subarea 620_2. The hand 320 touches the first subarea 620_1, and the second subarea 620_2 is all detection area on the touch display panel 520 other than the first area 610 and the first subarea 620_1. The first subarea 620_1 is smaller than the second subarea 620_2. The driver circuit 110 makes the driving lines corresponding to the first subarea 620_1 and the second subarea 620_2 to be in the high impedance state when the touch display panel 120 detects the touch event of the stylus 310 and the hand 320.

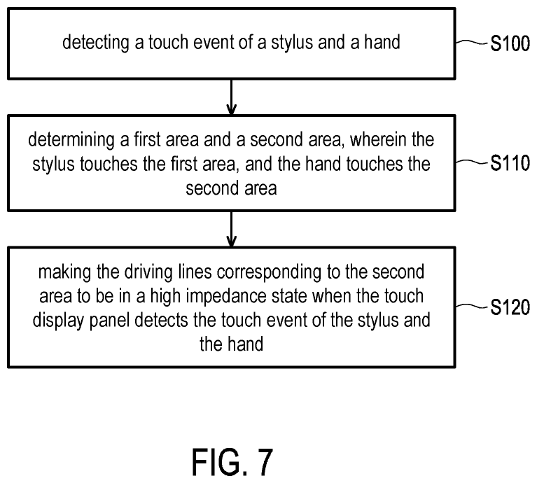

FIG. 7 is a flowchart illustrating steps in a method for driving a touch display panel according to an embodiment of the invention. Referring to FIG. 1 to FIG. 3, FIG. 6 and FIG. 7, in the present embodiment, the method for sensing the at least one fingerprint image is at least adapted to the electronic device 100 depicted in FIG. 1, but the disclosure is not limited thereto.

Taking the electronic device 100 for example, in step S100, the driver circuit 110 drives the touch display panel 520 to detect a touch event of a stylus 310 and a hand 320. In step S120, the driver circuit 110 determines a first area 610 and a second area 620, wherein the stylus 310 touches the first area 610, and the hand 320 touches the second area 620, and the second area 620 is all detection area on the touch display panel 520 other than the first area 610. In an embodiment, the driver circuit 110 determines whether the detection area is the first area 610 or the second area 620 according to at least one of a unit signal value, a total signal value, a signal peak value, and an area size of the least one touch sensing unit 622.

In step S120, the driver circuit 110 makes the driving lines corresponding to the second area 620 to be in a high impedance state when the touch display panel 520 detects the touch event of the stylus 310 and the hand 320. Therefore, the driver circuit 110 can only scan the first area 610 of the touch display panel 520 during a touch term to reduce the impact of hands or other interference.

The method for driving the touch display panel described in the embodiment of the invention is sufficiently taught, suggested, and embodied in the embodiments illustrated in FIG. 1 to FIG. 6, and therefore no further description is provided herein.

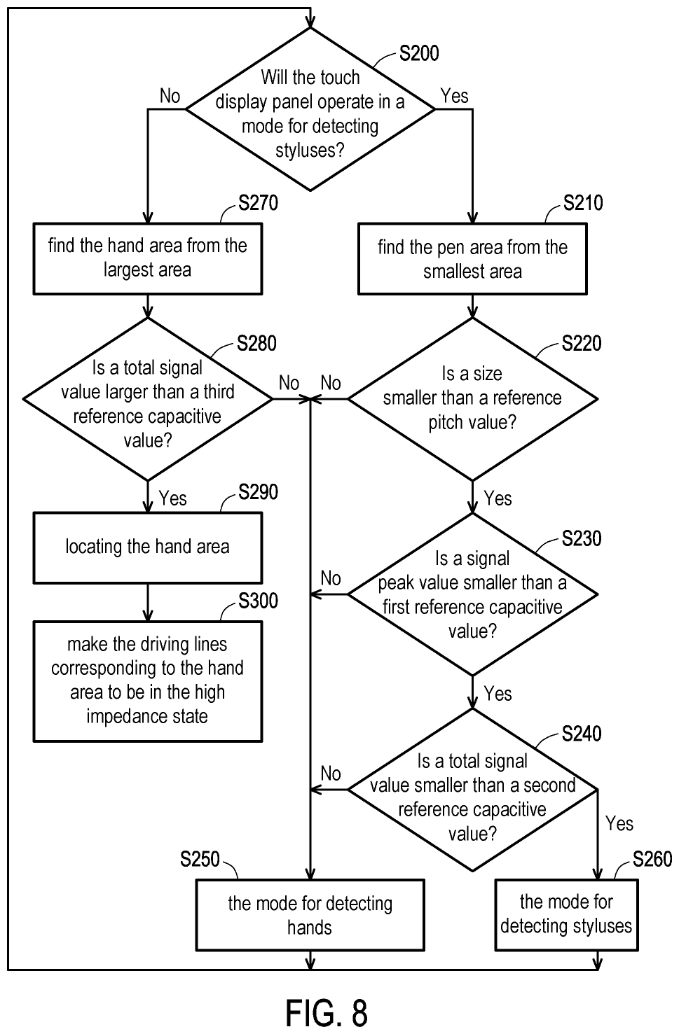

FIG. 8 is a flowchart illustrating steps in a method for driving a touch display panel according to another embodiment of the invention. Referring to FIG. 1 to FIG. 3, FIG. 6 and FIG. 8, in the present embodiment, the method for detecting styluses is at least adapted to the electronic device 100 depicted in FIG. 1, but the disclosure is not limited thereto.

In step S200, the driver circuit 110 determines whether the touch display panel 520 will operate in a mode for detecting styluses. If the touch display panel 520 will operate in the mode for detecting styluses, the driver circuit 110 performs step S210. In step S210, the driver circuit 110 expects to find the pen area (the first area) 610 from the smallest area.

Next, in step S220, the driver circuit 110 determines the size of the pen area 610

according to unit signal values of touch sensing units, and whether the determined size of the pen area 610 is smaller than a reference pitch value. The unit signal value indicates the capacitive value of the touch sensing unit to be determined. If the determined size of the pen area 610 is smaller than the reference pitch value, e.g. three pitches, but is not a limitation of the invention, the driver circuit 110 determines the area to be determined is the pen area 610 and performs step S230. If the determined size of the pen area 610 is larger than or equal to the reference pitch value, the driver circuit 110 determines the area to be determined is not the pen area 610 and performs step S250. In step S250, the driver circuit 110 drives the touch display panel 520 to operate in a mode for detecting hands. In the mode for detecting hands, the driver circuit 110 scan all detection area of the touch display panel 520.

In step S230, the driver circuit 110 determines whether a signal peak value, i.e. a maximum signal value, of the touch sensing units of the pen area 610 is smaller than a first reference capacitive value. If the signal peak value of the touch sensing units of the pen area 610 is smaller than the first reference capacitive value, e.g. 180 pF, but is not a limitation of the invention, the driver circuit 110 determines the area to be determined is the pen area 610 and performs step S240. If the signal peak value of the touch sensing units of the pen area 610 is larger than or equal to the first reference capacitive value, the driver circuit 110 determines the area to be determined is not the pen area 610 and performs step S250.

In step S240, the driver circuit 110 determines whether a total signal value, i.e. a summation of the signal values, of the touch sensing units of the pen area 610 is smaller than a second reference capacitive value. If the total signal value of the touch sensing units of the pen area 610 is smaller than the second reference capacitive value, e.g. 300 pF, but is not a limitation of the invention, the driver circuit 110 determines the area to be determined is the pen area 610 and performs step S260. In step S260, the driver circuit 110 drives the touch display panel 520 to operate in the mode for detecting styluses. In the mode for detecting styluses, the driver circuit 110 only scans the pen area 610, and makes the driving lines corresponding to the area 620 other than the pen area 610 to be in the high impedance state. If the total signal value of the touch sensing units of the pen area 610 is larger than or equal to the second reference capacitive value, the driver circuit 110 determines the area to be determined is not the pen area 610 and performs step S250.

In steps S220, S230 and S240, the driver circuit 110 determines whether the detection area is the pen area 610 according to the unit signal value, the total signal value, the signal peak value, and the area size of the touch sensing units, but the invention is not limited thereto. In an embodiment, the driver circuit can determine whether the detection area is the pen area according to at least one of the unit signal value, the total signal value, the signal peak value, and the area size of the least one touch sensing unit.

After steps S220, S230 and S240, the driver circuit 110 can locate the pen area 610. In an embodiment, the driver circuit 110 can repeat steps S220, S230 and S240 many times to ensure the location of the pen area 610 is correct.

On the other hand, if the touch display panel 520 will not operate in the mode for detecting styluses, the driver circuit 110 performs step S270. In step S270, the driver circuit 110 expects to find the hand area (the second area) from the largest area.

In step S280, the driver circuit 110 determines whether a total signal value, i.e. a summation of the signal values, of the touch sensing units of the hand area 620_1 is larger than a third reference capacitive value. If the total signal value of the touch sensing units of the hand area 620_1 is larger than the third reference capacitive value, e.g. 2000 pF, but is not a limitation of the invention, the driver circuit 110 determines the area to be determined is the hand area 620_1 and locates the hand area 620_1 in step S290. If the total signal value of the touch sensing units of the hand area 620_1 is smaller than or equal to the third reference capacitive value, the driver circuit 110 determines the area to be determined is not the hand area 620_1 and performs step S250.

In step S300, the driver circuit 110 makes the driving lines corresponding to the hand area 620_1 (the first subarea) to be in the high impedance state for locating the pen area 610 easily. After step S300, the driver circuit 110 may return to step S210 to further locate the pen area 610.

In steps S280, the driver circuit 110 determines whether the detection area is the hand area 620_1 according to the total signal value of the touch sensing units, but the invention is not limited thereto. In an embodiment, the driver circuit can determine whether the detection area is the hand area according to at least one of the unit signal value, the total signal value, the signal peak value, and the area size of the least one touch sensing unit.

The method for driving the touch display panel described in the embodiment of the invention is sufficiently taught, suggested, and embodied in the embodiments illustrated in FIG. 1 to FIG. 7, and therefore no further description is provided herein.

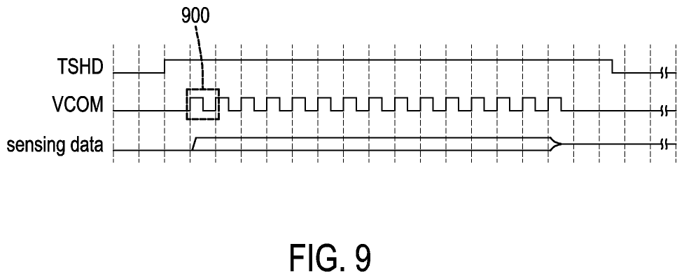

FIG. 9 is a waveform diagram illustrating a touch sensing signal, a common signal and a sensing data according to an embodiment of the invention. Referring to FIG. 9, the high level period of the touch sensing signal TSHD indicates a touch term. The common signal VCOM indicates the sensing data of the stylus 310 accumulated many times. A dashed box 900 indicates the sensing data of the stylus 310 accumulated once. That is, the driver circuit 110 can increase signal accumulation times of the stylus 310 during the touch term since the driver circuit 110 only scans the pen area 610 of the touch display panel 520 during the touch term.

In summary, in the embodiments of the invention, the driver circuit can locate the stylus according to the unit signal value, the total signal value, the signal peak value, and/or the area size of the touch sensing units. For the pen area, the driver circuit enhances the signal-to-noise ratio of the stylus by increasing signal accumulation times during the touch term to minimize the effect of noise. For the area other than the pen area, the driver circuit makes driving lines of the area other than the pen area to be in a high impedance state when the touch display panel detects the touch event of the stylus and the hand to reduce the impact of hands or other interference. Therefore, the electronic device and the method for driving the touch display panel are capable of effectively distinguishing styluses' touch from hands or other interference, so as to provide good user experience.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

To the claims:

1. An electronic device, configured to detect a touch event of a stylus and a hand, the electronic device comprising:
a touch display panel, configured to detect the touch event of the stylus and the hand, wherein the touch display panel comprises a plurality of driving lines; and
a driver circuit, coupled to the touch display panel, and configured to determine a first area and a second area, wherein the stylus touches the first area, and the hand touches the second area, and the driver circuit is configured to make the driving lines corresponding to the second area to be in a high impedance state when the touch display panel detects the touch event of the stylus and the hand,
wherein the touch display panel comprises a plurality of touch sensing units, at least one of the touch sensing units forms a detection area, and the driver circuit determines whether the detection area is the first area according to at least one of a unit signal value, a total signal value, a signal peak value, or an area size of the least one touch sensing unit.

2. The electronic device of claim 1, wherein the second area is all detection area on the touch display panel other than the first area.

3. The electronic device of claim 1, wherein the second area is larger than the first area.

4. (canceled)

5. The electronic device of claim 1, wherein the driver circuit only scans the first area of the touch display panel during a touch term.

6. The electronic device of claim 5, wherein the driver circuit increases signal accumulation times of the stylus during the touch term.

7. The electronic device of claim 1, wherein the second area comprises a first subarea and a second subarea, the hand touches the first subarea, and the driver circuit makes the driving lines corresponding to the first subarea to be in the high impedance state when the touch display panel detects the touch event of the stylus and the hand.

8. The electronic device of claim 7, wherein the driver circuit further makes the driving lines corresponding to the second subarea to be in the high impedance state when the touch display panel detects the touch event of the stylus and the hand.

9. The electronic device of claim 7, wherein the first subarea is smaller than the second subarea.

10. The electronic device of claim 7, wherein the driver circuit further determines whether the detection area is the first subarea according to at least one of the unit signal value, the total signal value, the signal peak value, or the area size of the least one touch sensing unit.

11. A method for driving a touch display panel having a plurality of driving lines, comprising:
detecting a touch event of a stylus and a hand;
determining a first area and a second area, wherein the stylus touches the first area, and the hand touches the second area; and
making the driving lines corresponding to the second area to be in a high impedance state when the touch display panel detects the touch event of the stylus and the hand, wherein the touch display panel comprises a plurality of touch sensing units, at least one of the touch sensing units forms a detection area, and the step of determining the first area and the second area comprises:
determining whether the detection area is the first area according to at least one of a unit signal value, a total signal value, a signal peak value, or an area size of the least one touch sensing unit.

12. The method of claim 11, wherein the second area is all detection area on the touch display panel other than the first area.

13. The method of claim 11, wherein the second area is larger than the first area.

14. (canceled)

15. The method of claim 11, further comprising:
only scanning the first area of the touch display panel during a touch term.

16. The method of claim 15, further comprising:
increasing signal accumulation times of the stylus during the touch term.

17. The method of claim 11, wherein the second area comprises a first subarea and a second subarea, the hand touches the first subarea, and the step of making the driving lines corresponding to the second area to be in the high impedance state when the touch display panel detects the touch event of the stylus and the hand comprises:
making the driving lines corresponding to the first subarea to be in the high impedance state when the touch display panel detects the touch event of the stylus and the hand.

18. The method of claim 17, wherein the step of making the driving lines corresponding to the second area to be in the high impedance state when the touch display panel detects the touch event of the stylus and the hand further comprises:
making the driving lines corresponding to the second subarea to be in the high impedance state when the touch display panel detects the touch event of the stylus and the hand.

19. The method of claim 17, wherein the first subarea is smaller than the second subarea.

20. The method of claim 17, wherein the step of determining the first area and the second area further comprises:
determining whether the detection area is the first subarea according to at least one of the unit signal value, the total signal value, the signal peak value, or the area size of the least one touch sensing unit.
